(19) United States
(12) Patent Application Publication
(10) Pub. No.: US 2020/0139840 A1
(43) Pub. Date: May 7, 2020

(54) Using Near-Field Communication (NFC) for Electric Vehicle Charging Authorization

(71) Applicant: ChargePoint, Inc., Campbell, CA (US)

(72) Inventors: Michael Roeder, Angelbachtal (DE); Joury de Reuver, Abcoude (NL)

(21) Appl. No.: 16/182,523

(22) Filed: Nov. 6, 2018

(51) Int. Cl. B60L 53/65; H04W 12/08; H04W 4/80

(52) U.S. Cl. CPC B60L 53/65; H04W 4/80; H04W 12/08

(57) ABSTRACT

A mobile device reads a near-field communication (NFC) tag of an electric vehicle supply equipment (EVSE). The NFC tag is encoded with an identifier of the EVSE. The mobile device transmits a charging session authorization request to a server to request authorization for a charging session at the EVSE, the request including the identifier of the EVSE and an access identifier of the electric vehicle operator. The server determines whether to grant authorization for the charging session. If granted, the server transmits a command to the EVSE to allow the charging session.

### FIELD

Embodiments of the invention relate to the field of electric vehicle charging, and more specifically to using near-field communication (NFC) for electric vehicle charging authorization.

### BACKGROUND

Electric vehicles are commonly charged through electric vehicle supply equipment (EVSE). Many EVSEs allow only authorized electric vehicle operators (EV operators) to access and use the EVSEs to charge their electric vehicle. EV operators have been able to present an access credential (e.g., an identifier, username/password, etc.) in different ways. Some EVSEs are configured to accept a request for a charging session by an EV operator waiving an RFID card that includes an access credential of the EV operator near an RFID reader of the EVSE. After receiving the access credential, the EVSE then either performs a local authorization or transmits the access identifier to a network server for authorization. If authorized, the server transmits a command to the EVSE to allow charging service.

As another example, some EVSEs include an NFC reader that is configured to read the access credential of the EV operator (typically presented with an electric vehicle charging application on a mobile client device of the EV operator). After receiving the access credential, the EVSE then either performs a local authorization or transmits the access identifier to a network server for authorization. If authorized, the server transmits a command to the EVSE to allow charging service.

### SUMMARY

One general aspect includes a method, including: reading, by a mobile client device, a near-field communication (NFC) tag of an electric vehicle supply equipment (EVSE); decoding, by the mobile client device, the NFC tag to reveal an identifier of the EVSE; transmitting, by the mobile client device, a charging session authorization request to an electric vehicle charging network server to request authorization for a charging session at the EVSE, where the charging session authorization request indicates the identifier of the EVSE and includes an access credential of an electric vehicle operator. The method also includes receiving, at the mobile client device, a message from the electric vehicle charging network server that indicates that the charging session has been authorized. The NFC tag may further reveal a digital path to the electric vehicle charging network server. Other embodiments of this aspect include corresponding computer systems, apparatus, and computer programs recorded on one or more computer storage devices, each configured to perform the actions of the methods.

One general aspect includes a method, including: encoding a unique identifier in a near-field communication (NFC) tag, where the unique identifier uniquely identifies an electric vehicle supply equipment (EVSE) to be connected to the NFC tag; receiving, from a mobile client device, a charging session authorization request that requests authorization to start a charging session at the EVSE, the charging session authorization request including an access credential of an electric vehicle operator and an identifier that identifies the EVSE; determining to authorize the charging session; responsive to the determining to authorize the charging session, transmitting a command to the EVSE to commence the charging session; and transmitting, to the mobile client device, a message that indicates that the charging session has been authorized. Other embodiments of this aspect include corresponding computer systems, apparatus, and computer programs recorded on one or more computer storage devices, each configured to perform the actions of the methods.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary charging system according to an embodiment;

FIG. 2 is a flow diagram that illustrates exemplary operations performed by a mobile client device to initiate a charging session according to an embodiment;

FIG. 3 is a flow diagram that illustrates exemplary operations performed by an EV charging network server according to an embodiment;

FIG. 4 illustrates an exemplary embodiment of an electric vehicle supply equipment (EVSE) according to an embodiment;

FIG. 5 illustrates a block diagram for an exemplary data processing system that may be used in some embodiments; and

FIG. 6 illustrates a block diagram for an exemplary data processing system that may be used in some embodiments.

### DETAILED DESCRIPTION

An improved way of requesting and commencing charging service is described, in one embodiment. An electric vehicle (EV) operator uses a mobile client device to read a near-field communication (NFC) tag of an EVSE. The NFC tag is encoded with a unique identifier that uniquely identifies the EVSE. This unique identifier is sometimes referred herein as the EVSE identifier. After reading and decoding the NFC tag, the mobile client device transmits a charging session authorization request to an electric vehicle charging network server to request authorization for a charging session. This charging session authorization request is typically sent over the internet to the network server (e.g., using a cellular data connection or a Wi-Fi connection of the mobile client device). The charging session authorization request includes the identifier of the EVSE and an access credential (e.g., an identifier, a username/password) of an electric vehicle operator. The electric vehicle charging network server determines whether the charging session is authorized based in part on the charging session authorization request. If the charging session is authorized for the electric vehicle operator and the identified EVSE, the electric vehicle charging network server transmits a command to that EVSE to commence the charging session. The electric vehicle charging network server may also transmit a message to the mobile client device that indicates that the charging session has been authorized. If the charging session is not authorized, the electric vehicle charging network server does not transmit a command to the EVSE to commence the charging session but may transmit a message to the mobile client device that indicates that the charging session has not been authorized.

The NFC tag may also be encoded with an instruction that causes a mobile client device that reads the NFC tag to automatically open an electric vehicle charging application on the mobile client device to transmit the charging session authorization request to the electric vehicle charging network server automatically. For instance, the NFC tag may be encoded with a deep link that causes the mobile client device to automatically open the electric vehicle charging application on the mobile client device if installed, or if not installed, the mobile client device prompts the user to install the electric vehicle charging application.

In an embodiment, if the EV operator does not have an account with the charging service, the mobile client device is directed to an NFC tag is encoded with an instruction that causes the mobile client device to direct to an URL of a page that allows the EV operator to register for charging service.

The NFC tag may also be encoded with a digital path (e.g., a URL) to a server of the EV charging network service. The user can be redirected to one or more different services based on the status of the EVSE and/or the role of the user. For example, upon receiving a request from a servicer of the EVSE that identifies the EVSE (the servicer may be an installer, a repairman, a manufacturer, etc.), the EV charging network service may determine the status of the EVSE and redirect the mobile client device of the servicer to different services depending on the status. If the status is normal (the EVSE is operating normally), the EV charging network service may redirect the mobile client device of the servicer to an EVSE details or configuration page, where the servicer can view and/or change certain aspects of the configuration page. If the status indicates the EVSE needs service, the EV charging network service may redirect the mobile client device of the servicer to an EVSE service page that may include diagnostic information and/or error information of the EVSE. If the status of the EVSE is “not activated”, the EV charging network service may redirect the mobile client device of the servicer to an activation page to “activate” the EVSE. If the status of the EVSE is unregistered, the EV charging network service may redirect the mobile client device of the servicer to a registration page, where the installer can provide registration information (e.g., EVSE specific details such as serial number, modem serial number, type, etc.).

As another example, upon receiving a request from an EV operator, the EV charging network service may determine the status of the EVSE and redirect the mobile client device of the EV operator to different pages depending on the EVSE status. If the status is normal (the EVSE is operating normally), the EV charging network service may determine whether the EV operator is authorized for charging and if so, it may transmit a command to the EVSE to commence the charging session. If the status indicates the EVSE needs service, the EV charging network service may redirect the mobile client device of the EV operator to a support page that provides support information for the EVSE and/or the charging network (e.g., contact information for support, etc.). If the status indicates the EVSE is not activated, the EV charging network service may redirect the mobile client device of the EV operator to a page that indicates that the EVSE is not yet activated including information to contact the station owner. If the status indicates the EVSE can be used only by users that have connected with the organization that owns or controls the EVSE, the EV charging network service may redirect the mobile client device of the EV operator to a connections page that allows the EV operator to connect with the organization or a message that this EVSE is not accessible to the public and a link to the closest public EVSE.

In an embodiment, the electric vehicle charging application is required to be open when reading the NFC tag. In such an embodiment, the mobile client device does not automatically open the electric vehicle charging application since it is already open.

In an embodiment, if the mobile client device does not have the electric vehicle charging application installed, the decoded NFC tag causes the mobile client device to prompt the user to install the electric vehicle charging application.

The NFC tag may be included in various places such as in sticker that is affixed to the outside of the EVSE, on the inside of the housing of the EVSE, and/or elsewhere included within the EVSE. The sticker may be affixed to the outside of the EVSE after the EVSE has been manufactured, such as out in the field. Thus, the EVSE may be retrofitted with the sticker that includes the NFC tag.

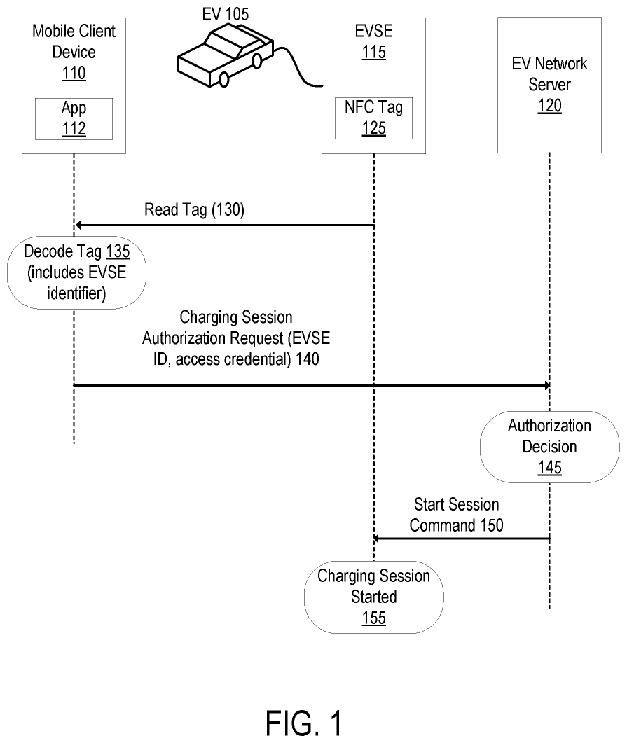

FIG. 1 illustrates an exemplary charging system according to an embodiment. The charging system illustrated in FIG. 1 includes the electric vehicle supply equipment (EVSE) 115. The EVSE 115 supplies electric energy for charging an electric vehicle such as the electric vehicle (“EV”) 105. The EV 105 may be a battery only EV (BEV), plug-in hybrid EV (PHEV), or other type of electric vehicle.

The EVSE 115 controls the supply of electric energy to an EV. For instance, the EVSE 115 may include control and logic to manage the charging of electric vehicles. The EVSE 115 may include one or more charging ports that are each configured to be coupled to an electric vehicle so that energy can be transferred between an electric vehicle and a power source. The charging port(s) may include a power receptacle (sometimes referred to as level 1 charging port) that is configured to accept plugs of a charging cord, circuitry for an attached cord (e.g., a level 2, level 3, or level 4 charging port), and/or circuitry for inductive charging. For example, in cases of level 1 charging, typically an electric vehicle (EV) operator plugs one end of the charging cord into the charging port and attaches the other end of the charging cord to the EV. In cases of level 2-4 charging, typically the charging cord is attached to the charging port and the EV operator only attaches the other end of the charging cord to the EV. In cases of inductive charging there are no charging cords to attach but the EV is put into proximity of the charging port and may be parked on a charging pad coupled to the charging port.

The EVSE 115 is coupled with an electric vehicle charging network server (“network server”) 120 over a communication link. The network server 120 may be coupled with the EVSE 115 over a Wide Area Network (WAN) such as the internet or a Local Area Network (LAN). The network server 120 is part of an EV charging network service that provides services related to charging for the EV operators. For instance, the network server 120 determines whether to authorize a charging session. A charging session is a period during which energy can be transferred between an electric vehicle and a power source through an EVSE. During the charging session, the electric vehicle is connected to the EVSE and typically is parked in a parking space assigned or associated with the EVSE. Although the network server 120 is illustrated as a single device, the network server 120 may be multiple devices and the operations described may be performed by multiple devices.

The network server 120 communicates with EV operators for various reasons including establishing charging service. The EV operators may be registered with the service and may be required to provide contact information (e.g., phone number for text messages, username for instant messages, and/or email address for email messages). The EV operators are typically the drivers of the electric vehicles. As will be described in greater detail later herein, an electric vehicle charging application on a mobile device can communicate with the EV charging network server 120.

The EVSE 115 includes the near-field communication (NFC) tag 125. The NFC tag 125 may be a passive NFC tag. The NFC tag 125 may be affixed to the outside of the EVSE 115 (e.g., a sticker) or may be included on the inside of the EVSE 115. The NFC tag 125 is encoded with a unique identifier that is tied to the EVSE 115. Thus, the unique identifier directly or indirectly identifies the EVSE 115. The NFC tag 125 may also be encoded with an instruction to open an electric vehicle charging application.

If the EVSE 115 includes multiple charging ports, then in an embodiment the EVSE 115 includes a separate NFC tag for each charging port. In such an embodiment, a unique charging port identifier may be encoded in the NFC tag.

The NFC tag 125 is configured to be read by a mobile client device, such as the mobile client device 110, and can be used when requesting a charging session. The mobile client device 110 is a computing device that typically runs a mobile operating system and may be, for example, a smartphone, tablet, wearable device (e.g., a smartwatch, smart glasses), laptop, etc. The mobile client device 110 includes the ability to read an NFC tag, such as the NFC tag 125.

The NFC tag 125 may be used by other users besides EV operators that are requesting a charging service. For instance, the NFC tag 125 may be read by a mobile client device of a servicer that is installing, activating, registering, and/or configuring the EVSE 115 for service. For example, the NFC tag may be encoded with a URL of a server of the EV charging network service that may redirect the servicer to one or more different services based on the status of the EVSE.

The mobile client device 110 may be configured to execute an electric vehicle charging application (“app”) 112. The electric vehicle charging application 112 provides functionality for electric vehicle operators including managing charging sessions to charge electric vehicles (e.g., transmitting a request for a charging session). The functionality may also include receiving notifications (e.g., when the vehicle is done charging, when an EVSE is available, etc.), finding available EVSEs, tracking usage, scheduling charging, paying for charging service, etc. In an embodiment, the electric vehicle charging application is optional and certain functionality including managing charging sessions may be done through an electric vehicle charging network operator website. A version of the app 112 may exist on a mobile client device of a servicer that has different functionality than the app for an EV operator, such as installing, activating, registering, and/or configuring the EVSE.

The EV 105 is an electric vehicle (e.g., a PHEV, a BEV, etc.) that is coupled with the EVSE 115. For example, the operator of the EV 105 has driven the vehicle to the EVSE 115 and may have connected the EV 105 to the EVSE 115 with an intention of charging the EVSE 115. The EV operator uses their mobile client device 110 to read the NFC tag 125 at operation 130. In an embodiment, the EV operator opens the electric vehicle charging application 112 as a prerequisite for reading the NFC tag 125. In another embodiment, the NFC tag 125 can be read by the mobile client device 110 without first opening the electric vehicle charging application 112.

Next, the mobile client device 110 decodes the NFC tag 125 at operation 135. The decoded NFC tag reveals a unique identifier that is tied to the EVSE 115 (referred as an EVSE identifier). The decoded NFC tag may also reveal an instruction for the mobile client device 110 to open the electric vehicle charging application 112 if not already open. Also, if the electric vehicle charging application 112 is not installed on the mobile client device 110, the decoded NFC tag may cause the mobile client device to prompt the user to install the electric vehicle charging application 112 (e.g., a link to download and install the electric vehicle charging application 112 may be provided to the EV operator). In a specific example, the decoded NFC tag may reveal a deep link that causes the mobile client device 110 to automatically open the electric vehicle charging application 112 on the mobile client device 110 if installed, or if not installed, the mobile client device 110 opens an application store to install the electric vehicle charging application 112. If the EVSE 115 includes multiple charging ports, then the decoded NFC tag may also reveal a charging port identifier. In an embodiment, the decoded NFC tag causes a browser (e.g., a mobile browser) to open to a website operated by the electric vehicle charging operator.

Next, after decoding the NFC tag, the mobile client device 110 transmits a charging session authorization request to the EV charging network server 120 at operation 140. The charging session authorization request includes the identifier of the EVSE 115 and an access credential (e.g., an identifier of the EV operator, a username/password of the EV operator). The charging session authorization request may alternatively or additionally include a unique charging port identifier if decoded from the NFC tag. The charging session authorization request is transmitted over the internet and does not travel through the EVSE 115. In an embodiment, the charging session authorization request is transmitted to the EV charging network server 120 automatically by the electric vehicle charging application 112. Thus, in such an embodiment, the EV operator simply reads the NFC tag (potentially with the electric vehicle charging application 112 being opened) to request a charging session at the EVSE 115. In another embodiment, the EV charging application or the EV charging network operator website prompts the EV operator to initiate the charging session at the EVSE 115 and transmits the charging session authorization request in response to receiving input from the EV operator to initiate the charging session at the EVSE 115.

The operation 140 assumes that EV operator has an access credential (e.g., is registered for service and has an access credential). If the EV operator does not have an access credential, the mobile client device 110 may be directed to a page that allows the EV operator to register for charging service and obtain an access credential.

The EV charging network server 120 receives the charging session authorization request from the mobile client device 110. The EV charging network server 120 performs an authorization decision procedure to determine whether to allow the requested charging session at the EVSE 115, at operation 145. The authorization decision procedure may take one or more factors into account including: whether the EV operator making the request is allowed to use the EVSE 115 at the time of the request and whether sufficient payment has been made for the charging session. In an embodiment, the authorization decision may include performing an authentication, authorization, and accounting (AAA) decision.

If the EV charging network server 120 determines to allow the requested charging session, then the EV charging network server 120 transmits a start session command to the EVSE 115 that instructs the EVSE 115 to commence the charging session, at operation 150. The EV charging network server 120 may also transmit a message to the mobile client device 110 that indicates that the charging session has been authorized, which may be displayed on the electric vehicle charging application 112 or through the browser of the mobile client device 110. If the EV charging network server 120 determines to not allow the requested charging session, then the EV charging network server 120 does not transmit a start session command to the EVSE 115 but may transmit a message to the mobile client device 110 indicating that the charging session request was not granted.

The EVSE 115 receives the start session command from the EV charging network server 120 and, at operation 155, starts the charging session (assuming that the EV 105 has been connected to the EVSE 115). Starting the charging session may include the EVSE 115 allowing energy to be transferred to the EV 105. For example, the EVSE 115 may energize a charging port to allow energy to be transferred to the EV 105.

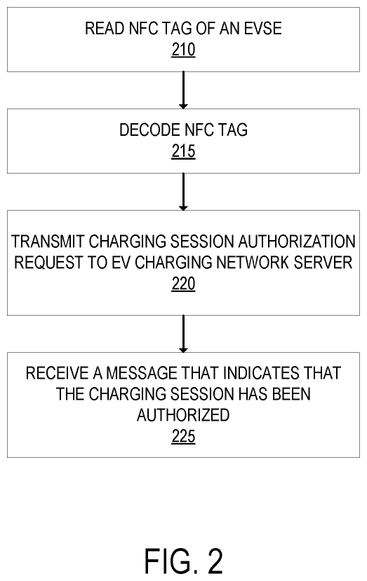

FIG. 2 is a flow diagram that illustrates exemplary operations performed by a mobile client device to initiate a charging session according to an embodiment. At operation 210, the mobile client device reads an NFC tag of an EVSE. The NFC tag is encoded with a unique identifier that is tied to the EVSE. If there are multiple charging ports on the EVSE where each charging port has an associated NFC tag, the NFC tag that is read by the mobile client device may be alternatively or additionally encoded with a unique identifier for that charging port (at least unique to the EVSE). The NFC tag may also be encoded with an instruction for the mobile client device to open an electric vehicle charging application if not already open or open a browser to a website of the EV charging network operator. The NFC tag may also be encoded with an instruction for the mobile client device to automatically initiate the request for a charging session. The NFC tag may be encoded with an instruction for the mobile client device to prompt the user to install the electric vehicle charging application if not installed on the mobile client device. The mobile client device may read the NFC tag when the user of the mobile client device places the mobile client device into proximity with the NFC tag. In some cases, the mobile client device may have the electric vehicle charging application running as a prerequisite for reading the NFC tag.

Next, at operation 215, the mobile client device decodes the NFC tag. The decoded NFC tag reveals the unique EVSE identifier. Additionally, or alternatively, the decoded NFC tag may reveal a charging port identifier of the EVSE. The decoded NFC tag may also reveal an instruction for the mobile client device an instruction for the mobile client device to open an electric vehicle charging application if not already open, and/or prompt the user to install the electric vehicle charging application if not installed. The decoded NFC tag may cause a browser (e.g., mobile browser) of the mobile client device to open to a website operated by the electric vehicle charging operator. The decoded NFC tag may also reveal an instruction for the mobile client device to automatically initiate a request for a charging session.

Next, at operation 220, the mobile client device transmits a charging session authorization request to an electric vehicle charging network server to request a charging session at the EVSE. The charging session authorization request includes an access credential (e.g., an identifier of the EV operator, a username/password of the EV operator), and the identifier of the EVSE and/or the identifier of the charging port. In an embodiment, the charging session authorization request is automatically transmitted by the electric vehicle charging application. In another embodiment, the EV charging application or the EV charging network operator website prompts the electric vehicle operator to initiate the charging session and transmits the charging session authorization request in response to receiving input from the electric vehicle operator to initiate the charging session. The charging session authorization request is transmitted over the internet.

The electric vehicle charging network server receives the charging session authorization request and determines whether to grant the request for the charging session. If the request is granted, the electric vehicle charging network server transmits a command to the EVSE to commence the charging session to allow the electric vehicle of the EV operator to be charged using the EVSE. The electric vehicle charging network server also transmits a message to the mobile client device that indicates that the charging session has been authorized. Thus, at operation 225, the mobile client device receives a message from the electric vehicle charging network server that indicates that the requested charging session has been authorized. The EV charging application may display the message. If the charging session is not allowed, the mobile client device will receive a message indicating that the requested charging session has not been authorized.

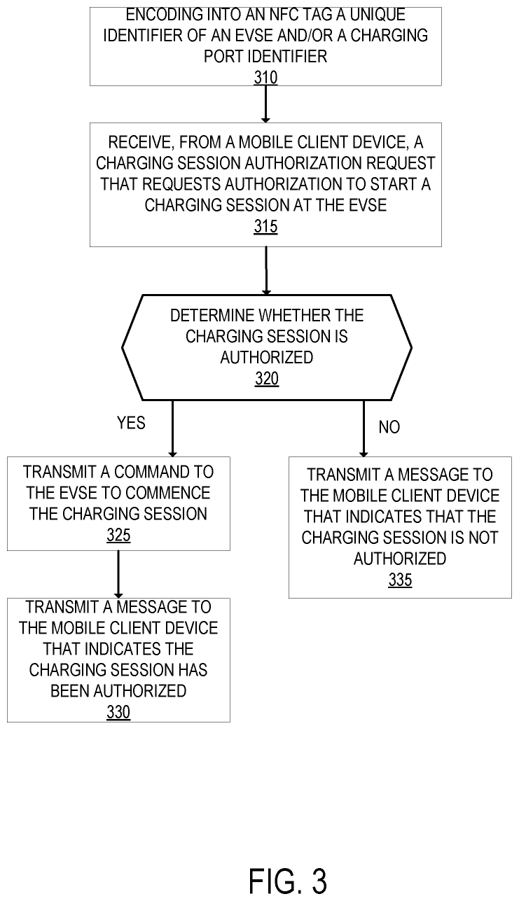

FIG. 3 is a flow diagram that illustrates exemplary operations performed by an EV charging network server according to an embodiment. At operation 310, the EV charging network server codes a unique identifier of an EVSE and/or a charging port identifier into an NFC tag. The NFC tag is to be affixed or included in the EVSE in an area in which it can be read by a mobile client device of an EV operator. The NFC tag may be encoded with an instruction that causes the mobile client device to open an electric vehicle charging application and/or prompt the EV operator to install the electric vehicle charging application if not installed on the mobile client device.

At operation 315, the EV charging network server receives a charging session authorization request from a mobile client device of an EV operator. The charging session authorization requests authorization to start a charging session at an EVSE. The charging session authorization request includes an access credential (e.g., an identifier of the EV operator, a username/password of the EV operator), and the identifier of the EVSE and/or the identifier of a charging port.

Next, at operation 320, the EV charging network server determines whether the requested charging session is authorized. For instance, the EV charging network server may determine whether the identified EV operator is allowed to use the EVSE and/or the charging port at the time of the request and/or whether sufficient payment has been made for the charging session. If the requested charging session is authorized, then at operation 325, the EV charging network server transmits a command to the EVSE to commence the charging session. Also, at operation 330, the EV charging network server transmits a message to the mobile client device that indicates the charging session has been authorized. If, however, the requested charging session is not authorized, then at operation 335, the EV charging network server transmits a message to the mobile client device that indicates that the charging session is not authorized.

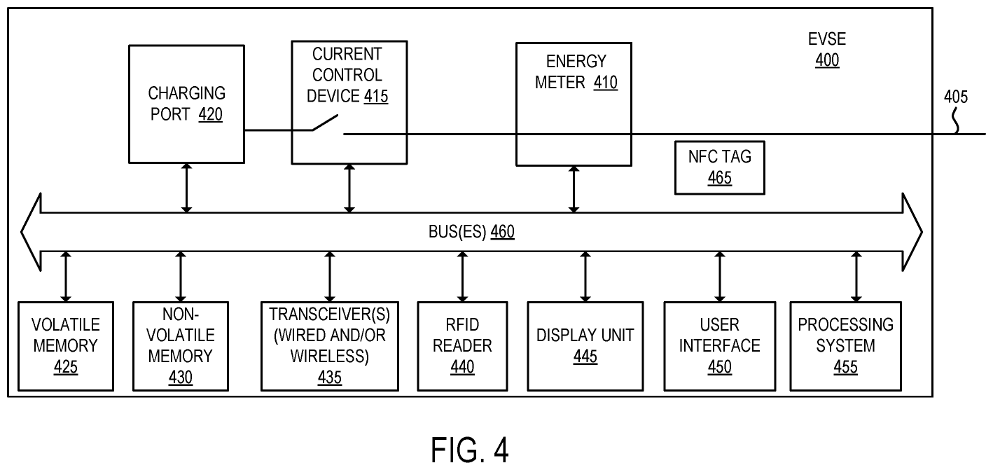

FIG. 4 illustrates an exemplary embodiment of an EVSE according to an embodiment. FIG. 4 illustrates an exemplary architecture of an EVSE, and other, different architectures may be used in embodiments. Although several components are illustrated as being included in the EVSE 400, in some embodiments additional, different, or less components may be used in the EVSE 400. For example, some EVSE may not include a display or a user interface. The EVSE 115 may take the form of the EVSE 400.

As illustrated in FIG. 4, the EVSE 400 includes the energy meter 410, the current control device 415, the charging port 420, the volatile memory 425, the non-volatile memory 430 (e.g., hard drive, flash, PCM, etc.), one or more transceiver(s) 435 (e.g., wired transceiver(s) (e.g., Ethernet, power line communication (PLC), etc.) and/or wireless transceiver(s) (e.g., 802.15.4 (e.g., ZigBee, etc.), Bluetooth, Wi-Fi, Infrared, GPRS/GSM, CDMA, etc.)), the RFID reader 440, the display unit 445, the user interface 450, and the processing system 455 (e.g., one or more microprocessors and/or a system on an integrated circuit), which may be coupled with one or more buses 460, and the NFC tag 465.

The energy meter 410 measures the amount of electricity that is flowing on the power line 405 through the charging port 420. While in one embodiment the energy meter 410 measures current flow, in an alternative embodiment the energy meter 410 measures power draw. The energy meter 410 may be an induction coil or other devices suitable for measuring electricity. In some embodiments, the energy meter 410 is a programmable time of use energy meter (e.g., programmed according to the prices and time periods defined by the owner or operator of the EVSE). While the energy meter 410 is illustrated as being included within the EVSE 400, in other embodiments the energy meter 410 is exterior to the EVSE 400 but capable of measuring the amount of electricity flowing on the power line 405 through the charging port 420.

The charging port 420 is a power receptacle, circuitry for an attached charging cord (e.g., with a SAE J1772 connector), or circuitry for inductive charging. While FIG. 4 illustrates a single charging port 420, the EVSE 400 may include multiple charging ports and which may be the same or different types.

The current control device 415 is a solid-state device that is used to control the current flowing on the power line 405 or any other device suitable for controlling the current flowing on the power line 405. For example, in some embodiments the current control device 415 energizes the charging port 420 (e.g., by completing the circuit to the power line 405) or de-energizes the charging port 420 (e.g., by breaking the circuit to the power line 405). In some embodiments the current control device 415 energizes the charging port 420 responsive to receiving a command from a server that indicates that an electric vehicle operator is authorized to use the charging port.

The RFID reader 440 reads RFID tags from RFID enabled devices (e.g., smartcards, key fobs, contactless credit cards, etc.), embedded with RFID tag(s) of operators that want to use the charging port 420 of the EVSE 400. For example, in some embodiments a vehicle operator can wave/swipe an RFID enabled device near the RFID reader 430 to provide an access credential for use of the charging port 420. Electric vehicle operators may use the RFID reader 440 for payment. In addition to an RFID reader, the EVSE 400 may also include a credit card reader.

The NFC tag 465 is encoded with information as previously described herein. Instead of using an RFID enabled device to request a charging session, an electric vehicle operator can place an NFC-enabled device to read the NFC tag 465 to initiate the charging session authorization request.

The transceiver(s) 435 transmit and receive messages. For example, the transceiver(s) 435 may transmit authorization requests to the EV charging network server, receive commands from the EV charging network server indicating whether the charging session is authorized, etc.

The display unit 445 is used to display messages to vehicle operators including charging status, confirmation messages, error messages, notification messages, etc. The display unit 445 may also display parking information if the EVSE 400 is also acting as a parking meter (e.g., amount of time remaining in minutes, parking violation, etc.).

The user interface 450 allows users to interact with the EVSE 400. By way of example, the user interface 450 allows electric vehicle operators to present an access credential, enter in account and/or payment information, etc.

The processing system 455 may retrieve instruction(s) from the volatile memory 425 and/or the nonvolatile memory 430 and execute the instructions to perform operations as previously described herein.

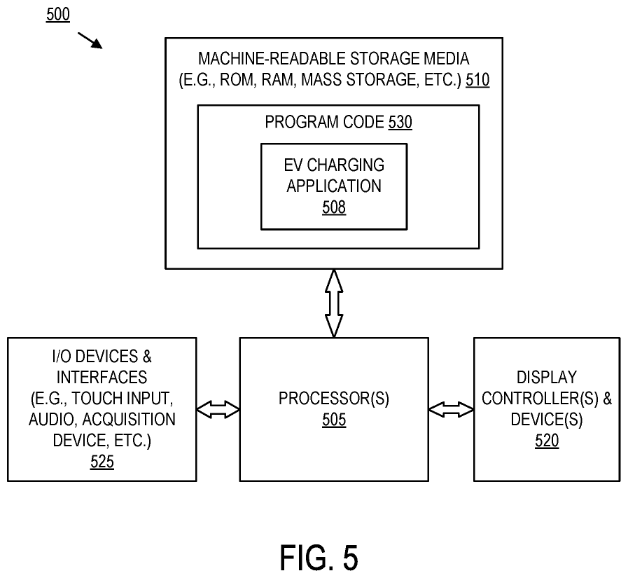

FIG. 5 illustrates a block diagram for an exemplary data processing system 500 that may be used in some embodiments. Data processing system 500 includes one or more processors 505 and connected system components (e.g., multiple connected chips). One or more such data processing systems 500 may be utilized to implement the embodiments and operations described with respect to the mobile client device.

The data processing system 500 is an electronic device which stores and transmits (internally and/or with other electronic devices over a network) code (which is composed of software instructions and which is sometimes referred to as computer program code or a computer program) and/or data using machine-readable media (also called computer-readable media), such as machine-readable storage media 510 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processor(s) 505. For example, the depicted machine-readable storage media 510 may store program code 530 that, when executed by the processor(s) 505, causes the data processing system 500 to execute the EV charging application 508.

The data processing system 500 may also include a display controller and display device 520 to provide a visual user interface for the user, e.g., GUI elements or windows. The visual user interface (or graphical interface) may be used to enable an electric vehicle operator to request a charging session, view messages from the EV charging network server, etc.

The data processing system 500 also includes one or more input or output (“I/O”) devices and interfaces 525, which are provided to allow a user to provide input to, receive output from, and otherwise transfer data to and from the system. These I/O devices 525 may include a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. The I/O devices and interfaces 525 may include wireless transceivers, such as an IEEE 802.11 transceiver, an infrared transceiver, a Bluetooth transceiver, a wireless cellular telephony transceiver (e.g., 2G, 3G, 4G, 5G), an NFC transceiver, or another wireless protocol to connect the data processing system 500 with another device, external component, or a network and receive stored instructions, data, tokens, etc. For instance, a wired or wireless transceiver may transmit and receive messages to and from the EV network server as described herein.

Additional components, not shown, may also be part of the system 500, and, in certain embodiments, fewer components than that shown in FIG. 5 may also be used in a data processing system 500. One or more buses may be used to interconnect the various components shown in FIG. 5.

Thus, an electronic device (e.g., a computer or a mobile client device) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

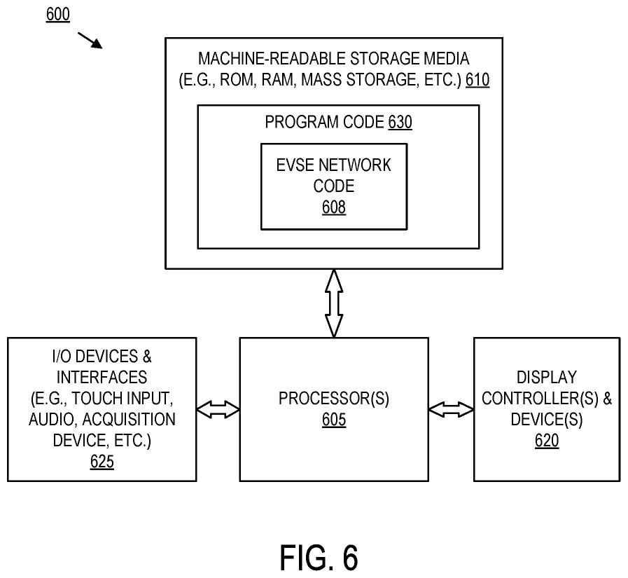

FIG. 6 illustrates a block diagram for an exemplary data processing system 600 that may be used in some embodiments. Data processing system 600 includes one or more processors 605 and connected system components (e.g., multiple connected chips). Alternatively, the data processing system 600 is a system on a chip or Field-Programmable gate array. One or more such data processing systems 600 may be utilized to implement the embodiments and operations described with reference to the EV charging network server.

The data processing system 600 is an electronic device which stores and transmits (internally and/or with other electronic devices over a network) code (which is composed of software instructions and which is sometimes referred to as computer program code or a computer program) and/or data using machine-readable media (also called computer-readable media), such as machine-readable storage media 610 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processor(s) 605. For example, the depicted machine-readable storage media 610 may store program code 630 that, when executed by the processor(s) 605, causes the data processing system 600 to execute the EVSE network code 608. The EVSE network code 608, when executed by the processor(s) 605, causes the data processing system 600 to perform the operations described with reference to FIGS. 1 and 3, for example. In some embodiments, the EVSE network code 608 may be stored on a centralized (backend) electronic device that is in communication with multiple electronic devices. In some embodiments, the EVSE network code 608 may include one or more subsets of codes stored on separate electronic devices, where each subset when executed on the respective electronic device causes the electronic device to perform some or all of the operations described with reference to FIGS. 1 and 3.

The data processing system 600 also includes one or more input or output (“I/O”) devices and interfaces 625 to transfer data to and from the system. The I/O devices and interfaces 625 may also include a connector for a dock or a connector for a USB interface, FireWire, Thunderbolt, Ethernet, etc., to connect the system 600 with another device, external component, or a network. Exemplary I/O devices and interfaces 625 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 600 with another device, external component, or a network and receive stored instructions, data, tokens, etc. For instance, a wired or wireless transceiver may transmit and receive messages to and from a mobile client device as described herein. The data processing system 600 may include a display controller and display device 620 to provide a visual user interface for the user, e.g., GUI elements or windows.

Additional components, not shown, may also be part of the system 600, and, in certain embodiments, fewer components than that shown in FIG. 6 may also be used in a data processing system 600. One or more buses may be used to interconnect the various components shown in FIG. 6.

Thus, an electronic device (e.g., an EV charging network server) includes hardware and software, such as a set of one or more processors coupled to one or more machine-readable storage media to store code for execution on the set of processors and/or to store data. For instance, the electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment may be implemented using different combinations of software, firmware, and/or hardware.

In the preceding description, numerous specific details are set forth in order to provide a more thorough understanding. However, control structures, gate level circuits and full software instruction sequences have not been shown in detail in order not to obscure understanding. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is within the knowledge of one skilled in the art to affect such feature, structure, or characteristic in connection with other embodiments whether or not explicitly described.

While the flow diagrams in the figures show a particular order of operations performed by certain embodiments, it should be understood that such order is exemplary (e.g., alternative embodiments may perform the operations in a different order, combine certain operations, overlap certain operations, etc.).

While several embodiments have been described, those skilled in the art will recognize that the invention is not limited to the embodiments described and can be practiced with modification and alteration within the spirit and scope of the appended claims. The description is thus to be regarded as illustrative instead of limiting.

What is claimed is:

1. A method, comprising:
reading, by a mobile client device, a near-field communication (NFC) tag of an electric vehicle supply equipment (EVSE);
decoding, by the mobile client device, the NFC tag to reveal an identifier of the EVSE;
transmitting, by the mobile client device, a charging session authorization request to an electric vehicle charging network server to request authorization for a charging session at the EVSE, wherein the charging session authorization request includes:
the identifier of the EVSE, and
an access credential of an electric vehicle operator; and
receiving, at the mobile client device, a message from the electric vehicle charging network server that indicates that the charging session has been authorized.

2. The method of claim 1, further comprising:
wherein the decoded NFC tag further includes an instruction for the mobile client device to open an electric vehicle charging application on the mobile client device;
automatically opening the electric vehicle charging application on the mobile client device;
wherein the transmitting the charging session authorization request is caused by the electric vehicle charging application; and
wherein the message from the electric vehicle charging network server that indicates that the charging session has been authorized is received on the electric vehicle charging application and displayed.

3. The method of claim 1, further comprising:
wherein the decoded NFC tag further includes an instruction for the mobile client device to open an electric vehicle charging application on the mobile client device;
determining that the electric vehicle charging application is not installed on the mobile client device;
responsive to the determining that the electric vehicle charging application is not installed on the mobile client device, prompting a user to install the electric vehicle charging application;
wherein the transmitting the charging session authorization request is caused by the electric vehicle charging application once installed; and
wherein the message from the electric vehicle charging network server that indicates that the charging session has been authorized is received on the electric vehicle charging application and displayed after the electric vehicle charging application is installed.

4. The method of claim 1, further comprising:
wherein the decoded NFC tag further includes an instruction for the mobile client device to open a mobile browser on the mobile client device;
opening the mobile browser on the mobile client device to a website of an electric vehicle charging network service to allow the electric vehicle operator to request authorization for a charging session at the EVSE;
wherein the transmitting the charging session authorization request is caused by the mobile browser; and
wherein the message from the electric vehicle charging network server that indicates that the charging session has been authorized is received and displayed by the mobile browser.

5. The method of claim 1, wherein the charging session authorization request is transmitted automatically by the mobile client device.

6. The method of claim 1, wherein the NFC tag further reveals a digital path to the electric vehicle charging network server.

7. The method of claim 1, further comprising:
reading, by a different mobile client device, the NFC tag of the EVSE;
decoding, by the different mobile client device, the NFC tag to reveal the identifier of the EVSE;
transmitting, by the different mobile client device, a request to service the EVSE that includes the identifier of the EVSE and an access credential of a servicer;
receiving, at the different mobile client device, a redirection to a page that allows the servicer to service the EVSE.

8. A method, comprising:
encoding a unique identifier in a near-field communication (NFC) tag, wherein the unique identifier uniquely identifies an electric vehicle supply equipment (EVSE) to be connected to the NFC tag;
receiving, from a mobile client device, a charging session authorization request that requests authorization to start a charging session at the EVSE, the charging session authorization request including an access credential of an electric vehicle operator and an identifier that identifies the EVSE;
determining to authorize the charging session;
responsive to the determining to authorize the charging session, transmitting a command to the EVSE to commence the charging session; and
transmitting, to the mobile client device, a message that indicates that the charging session has been authorized.

9. The method of claim 8, further comprising:
encoding an instruction in the NFC tag that instructs the mobile client device to open an electric vehicle charging application on the mobile client device; and
wherein the charging session authorization request is received from the electric vehicle charging application on the mobile client device; and
wherein the message that indicates that the charging session has been authorized is transmitted to the electric vehicle charging application.

10. The method of claim 8, wherein the NFC tag is included on a sticker that is placed on the outside of the EVSE.

11. The method of claim 8, wherein the NFC tag is within the EVSE.

12. The method of claim 8, further comprising:
receiving, from a second mobile client device, a charging session authorization request that requests authorization to start a charging session at the EVSE, the charging session authorization request including an access credential of a second electric vehicle operator and the identifier that identifies the EVSE;
determining to not authorize the charging session;
responsive to the determining to not authorize the charging session,
transmitting, to the second mobile client device, a message that indicates that the charging session has not been authorized.

13. The method of claim 8, further comprising:
receiving, from a second mobile client device, a request to service the EVSE that includes the identifier of the EVSE and an access credential of a servicer;
determining a status of the EVSE; and
redirecting the second mobile client device to a page depending on the determined status of the EVSE.

14. The method of claim 13, further comprising:
wherein the determined status of the EVSE indicates the EVSE needs servicing; and
wherein the page is an EVSE service page that includes information of the EVSE.

15. The method of claim 13, further comprising:
wherein the determined status of the EVSE indicates the EVSE needs to be activated; and
wherein the page is an EVSE activation page that allows the servicer to activate the EVSE.

16. A non-transitory machine-readable storage medium that provides instructions that, when executed by a processor, cause said processor to perform operations comprising:
reading, by a mobile client device, a near-field communication (NFC) tag of an electric vehicle supply equipment (EVSE);
decoding, by the mobile client device, the NFC tag to reveal an identifier of the EVSE;
transmitting, by the mobile client device, a charging session authorization request to an electric vehicle charging network server to request authorization for a charging session at the EVSE, wherein the charging session authorization request includes:
the identifier of the EVSE, and
an access credential of an electric vehicle operator; and
receiving, at the mobile client device, a message from the electric vehicle charging network server that indicates that the charging session has been authorized.

17. The non-transitory machine-readable storage medium of claim 16, wherein the operations further comprise:
wherein the decoded NFC tag further includes an instruction for the mobile client device to open an electric vehicle charging application on the mobile client device;
automatically opening the electric vehicle charging application on the mobile client device;
wherein the transmitting the charging session authorization request is caused by the electric vehicle charging application; and
wherein the message from the electric vehicle charging network server that indicates that the charging session has been authorized is received on the electric vehicle charging application and displayed.

18. The non-transitory machine-readable storage medium of claim 16, wherein the operations further comprise:
wherein the decoded NFC tag further includes an instruction for the mobile client device to open an electric vehicle charging application on the mobile client device;
determining that the electric vehicle charging application is not installed on the mobile client device;
responsive to the determining that the electric vehicle charging application is not installed on the mobile client device, prompting a user to install the electric vehicle charging application;
wherein the transmitting the charging session authorization request is caused by the electric vehicle charging application once installed; and
wherein the message from the electric vehicle charging network server that indicates that the charging session has been authorized is received on the electric vehicle charging application and displayed after the electric vehicle charging application is installed.

19. The non-transitory machine-readable storage medium of claim 16, wherein the operations further comprise:
wherein the decoded NFC tag further includes an instruction for the mobile client device to open a mobile browser on the mobile client device;
opening the mobile browser on the mobile client device to a website of an electric vehicle charging network service to allow the electric vehicle operator to request authorization for a charging session at the EVSE;
wherein the transmitting the charging session authorization request is caused by the mobile browser; and
wherein the message from the electric vehicle charging network server that indicates that the charging session has been authorized is received and displayed by the mobile browser.

20. The non-transitory machine-readable storage medium of claim 16, wherein the charging session authorization request is transmitted automatically by the mobile client device.

21. The non-transitory machine-readable storage medium of claim 16, wherein the NFC tag further reveals a digital path to the electric vehicle charging network server.

22. The non-transitory machine-readable storage medium of claim 16, wherein the operations further comprise:
reading, by a different mobile client device, the NFC tag of the EVSE;
decoding, by the different mobile client device, the NFC tag to reveal the identifier of the EVSE;
transmitting, by the different mobile client device, a request to service the EVSE that includes the identifier of the EVSE and an access credential of a servicer;
receiving, at the different mobile client device, a redirection to a page that allows the servicer to service the EVSE.

23. A non-transitory machine-readable storage medium that provides instructions that, when executed by a processor, cause said processor to perform operations comprising:
encoding a unique identifier in a near-field communication (NFC) tag, wherein the unique identifier uniquely identifies an electric vehicle supply equipment (EVSE) to be connected to the NFC tag;
receiving, from a mobile client device, a charging session authorization request that requests authorization to start a charging session at the EVSE, the charging session authorization request including an access credential of an electric vehicle operator and an identifier that identifies the EVSE;
determining to authorize the charging session;
responsive to the determining to authorize the charging session, transmitting a command to the EVSE to commence the charging session; and
transmitting, to the mobile client device, a message that indicates that the charging session has been authorized.

24. The non-transitory machine-readable storage medium of claim 23, wherein the operations further comprise:
encoding an instruction in the NFC tag that instructs the mobile client device to open an electric vehicle charging application on the mobile client device; and
wherein the charging session authorization request is received from the electric vehicle charging application on the mobile client device; and
wherein the message that indicates that the charging session has been authorized is transmitted to the electric vehicle charging application.

25. The non-transitory machine-readable storage medium of claim 23, wherein the NFC tag is included on a sticker that is placed on the outside of the EVSE.

26. The non-transitory machine-readable storage medium of claim 23, wherein the NFC tag is within the EVSE.

27. The non-transitory machine-readable storage medium of claim 23, wherein the operations further comprise:
receiving, from a second mobile client device, a charging session authorization request that requests authorization to start a charging session at the EVSE, the charging session authorization request including an access credential of a second electric vehicle operator and the identifier that identifies the EVSE;
determining to not authorize the charging session;
responsive to the determining to not authorize the charging session,
transmitting, to the second mobile client device, a message that indicates that the charging session has not been authorized.

28. The non-transitory machine-readable storage medium of claim 23, wherein the operations further comprise:
receiving, from a second mobile client device, a request to service the EVSE that includes the identifier of the EVSE and an access credential of a servicer;
determining a status of the EVSE; and
redirecting the second mobile client device to a page depending on the determined status of the EVSE.

29. The non-transitory machine-readable storage medium of claim 28, wherein the operations further comprise:
wherein the determined status of the EVSE indicates the EVSE needs servicing; and
wherein the page is an EVSE service page that includes information of the EVSE.

30. The non-transitory machine-readable storage medium of claim 28, wherein the operations further comprise:
wherein the determined status of the EVSE indicates the EVSE needs to be activated; and
wherein the page is an EVSE activation page that allows the servicer to activate the EVSE.
